(19) United States
(12) Patent Application Publication
(10) Pub. No.: US 2017/0301492 A1
(43) Pub. Date: Oct. 19, 2017

(54) TEMPERATURE SWITCH

(71) Applicant: Yu-Kang YANG, Tainan City (TW)

(72) Inventor: Yu-Kang YANG, Tainan City (TW)

(21) Appl. No.: 15/130,699

(22) Filed: Apr. 15, 2016

(51) Int. Cl. H01H 37/00; H01H 37/12; H01H 37/48; H01H 37/04

(52) U.S. Cl. CPC H01H 37/002; H01H 37/04; H01H 37/12; H01H 37/48; H01H 2231/012

(57) ABSTRACT

A temperature switch includes a base having a receiving hole, and a conducting mechanism mounted on the base and having first and second conductive modules, a connection module connected electrically and releasably to the first and second conductive modules, and two deformable rods that are disposed in the receiving hole and that push the second conductive module to abut against the connection module. The second conductive module is moved away from the connection module when one of the deformable rods is deformed by temperature to switch the temperature switch from an energized position to a safety cut-off position.

### FIELD

The disclosure relates to a switch, and more particularly to a temperature switch that cuts off power supply of an electronic device by sensing a temperature.

### BACKGROUND

Referring to FIGS. 1 and 2, a temperature switch 1, as disclosed in the applicant's Taiwanese Utility Model Patent No. M498374, is configured to abut against a heater 11 and electrically connect-two electrical wires 12. The temperature switch 1 includes a base 13 having an accommodating chamber 130, a conducting mechanism 14 mounted on the base 13, and a temperature control mechanism 16 that is mounted on the base 13 and that abuts against the heater 11.

The conducting mechanism 14 includes a first terminal plate 141, a first connecting rod 142 connecting the first terminal plate 141 to the base 13, first and second conducting plates 143, 145 mounted in the accommodating chamber 130 of the base 13, a second terminal plate 146 located on a bottom of the base 13, a second connecting rod 147 electrically connected to the second terminal plate 146 and the second conducting plate 145, and a safety unit 148 mounted in a receiving hole 131 of the base 13 and electrically connected to the first conducting plate 143 and the first connecting rod 142. The safety unit 148 has an S-shaped conductive resilient bracket 149, and two temperature-dependent deformable rods 140 clamped in the conductive resilient bracket 149 and axially aligned with each other. The temperature control mechanism 16 abuts against the heater 11.

When the temperature of the heater 11 exceeds a temperature threshold, the temperature control mechanism 16 drives the second conducting plate 145 to move away from the first conducting plate 143 to cut off the power. If the temperature control mechanism 16 fails to perform a normal power off operation, or if the first and second conducting plates 143, 145 are abnormally stuck to each other, electric currents will unstoppably circulate through the electrical wires 12, thereby causing the ambient temperature to rise. When one of the temperature-dependent deformable rods 140 deforms and melts due to the high ambient temperature, the conductive resilient bracket 149 will resiliently separate from the first conducting plate 143 so as to switch the temperature switch 1 from an energized position to a safety cut-off position, as shown in FIG. 2.

Although the aforesaid temperature switch 1 has a safety function, because the safety unit 148 is located along the electric current flow path, under a normal use state, the temperature-dependent deformable rods 140 may be heated, melted and deformed, and worst case is, the power of the temperature switch 1 may be cut off. In addition, the manufacture of the S-shaped conductive resilient bracket 149 is complicated, the assembly of the conductive resilient bracket 149 and the temperature-dependent deformable rods 140 is inconvenient, and the components of the temperature switch 1 after assembly are unstable.

### SUMMARY

Therefore, an object of the disclosure is to provide a temperature switch that can alleviate the drawbacks of the prior art.

According to the disclosure, a temperature switch for electrical connection with two electrical wires includes a base having a receiving hole, a conducting mechanism and a temperature control mechanism.

The conducting mechanism is mounted on the base and includes a first conductive module for electrically connecting one of the electrical wires, a second conductive module for electrically connecting the other one of the electrical wires, a connection module connected electrically and releasably to the first and second conductive modules, and a safety unit including two deformable rods that are disposed in the receiving hole, that abut against each other, that are aligned along a longitudinal axis of the receiving hole, and that push the second conductive module to abut against the connection module.

The temperature control mechanism is mounted on the base and controls the first conductive module to move away from the connection module so as to switch the temperature switch from an energized position to a normal power off position.

The second conductive module is moved away from the connection module when one of the deformable rods is deformed by temperature to switch the temperature switch from the energized position to a safety cut-off position.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of a temperature switch disclosed in Taiwanese Utility Model Patent No. M498374;

FIG. 2 is a sectional view of the temperature switch in an assembled state;

FIG. 3 is an exploded perspective view of an embodiment of a temperature switch according to the disclosure;

FIG. 4 is a perspective view of a base of the embodiment;

FIG. 5 is an assembled top view of the embodiment;

FIG. 6 is a sectional view of the embodiment taken along line VI-VI of FIG. 5;

FIG. 7 is an exploded perspective view of a control rod, a cover body and a conducting mechanism of the embodiment;

FIG. 8 is a sectional view of the embodiment taken along line VIII-VIII of FIG. 5;

FIG. 9 is a bottom perspective view of the conducting mechanism of the embodiment; and

FIG. 10 is a view similar to FIG. 8, but illustrating a resilient contact portion of a second conductive plate separated from a conductive plate of a connection module.

### DETAILED DESCRIPTION

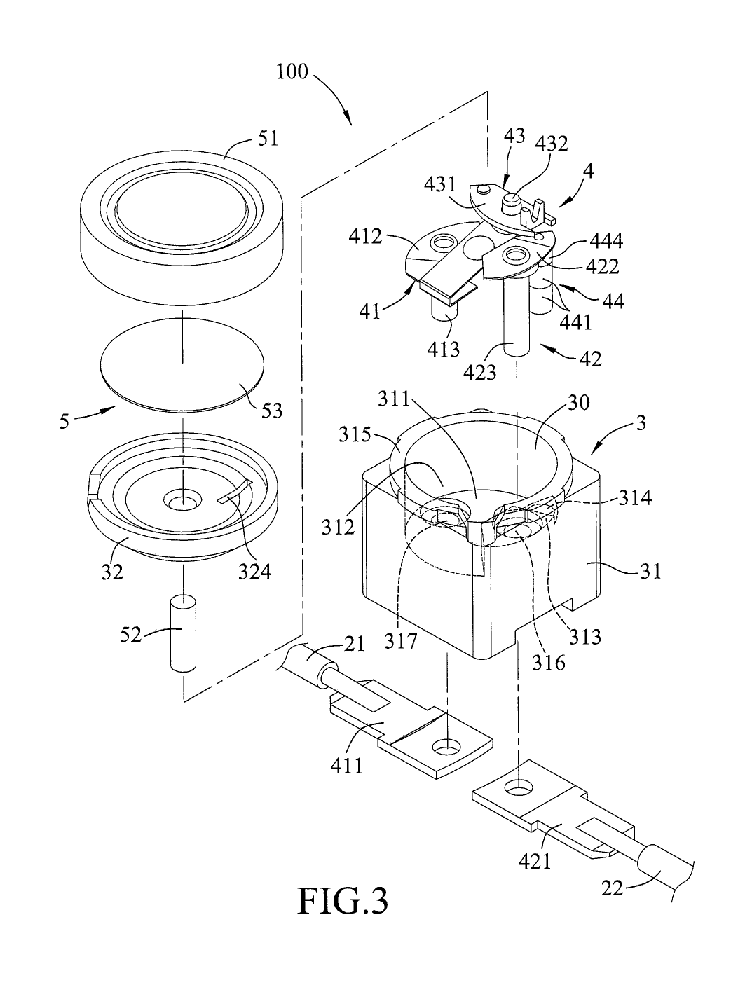

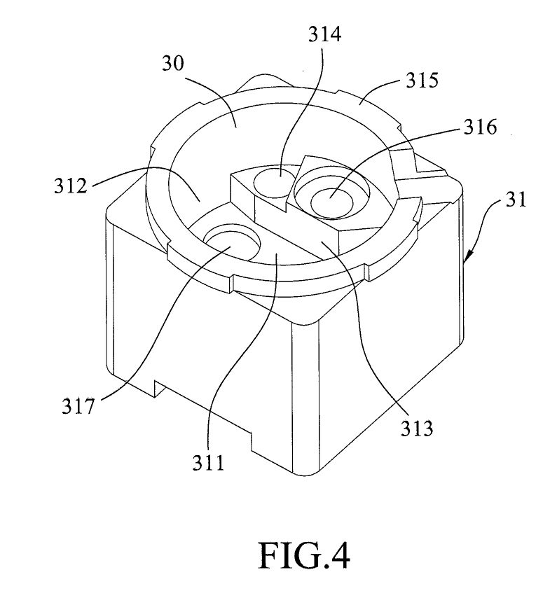

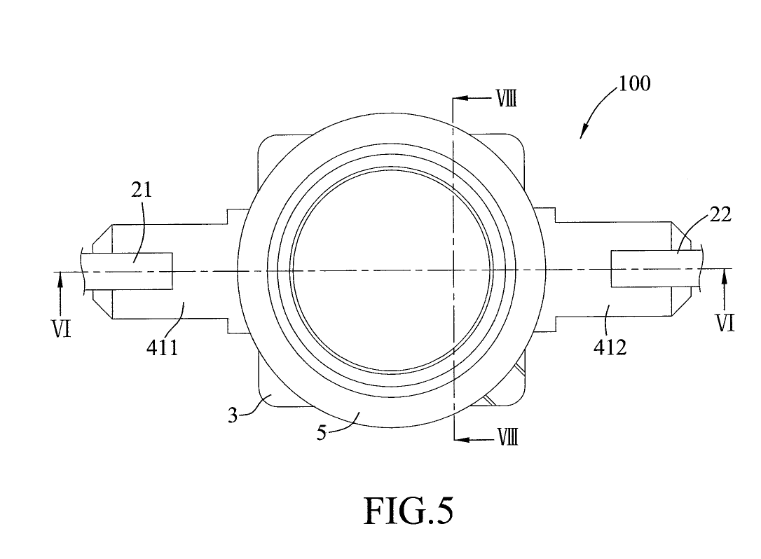

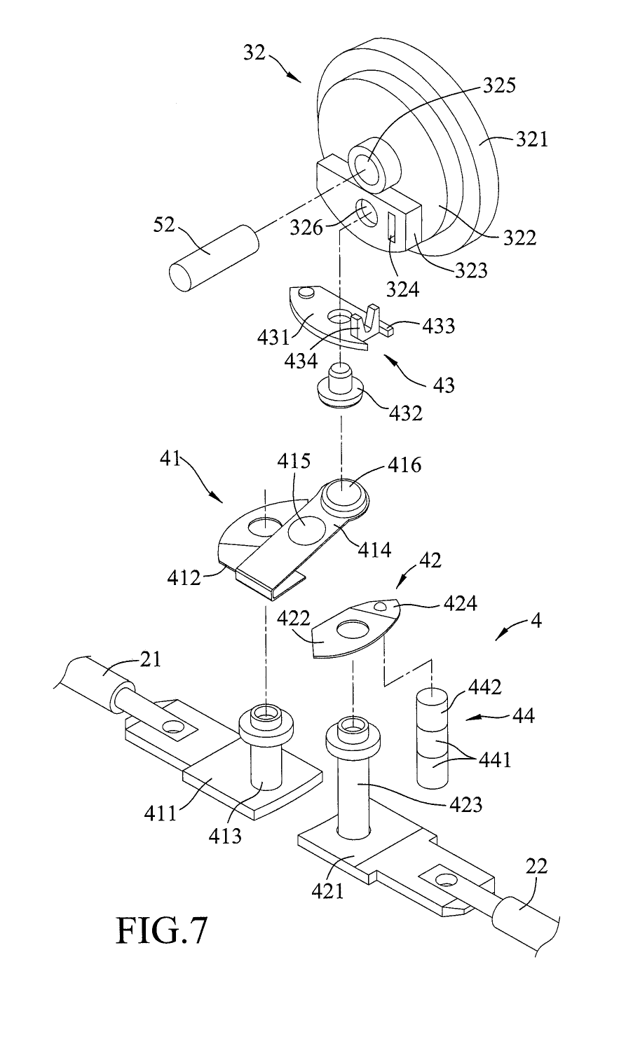

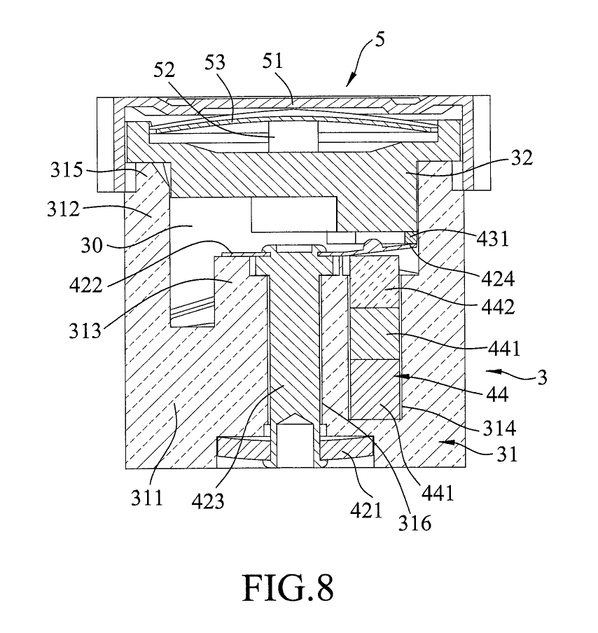

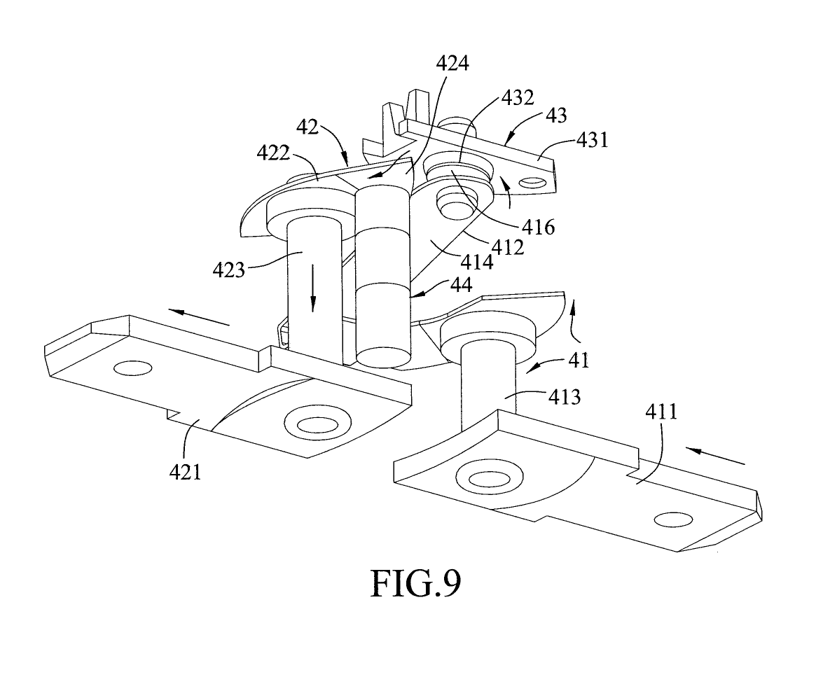

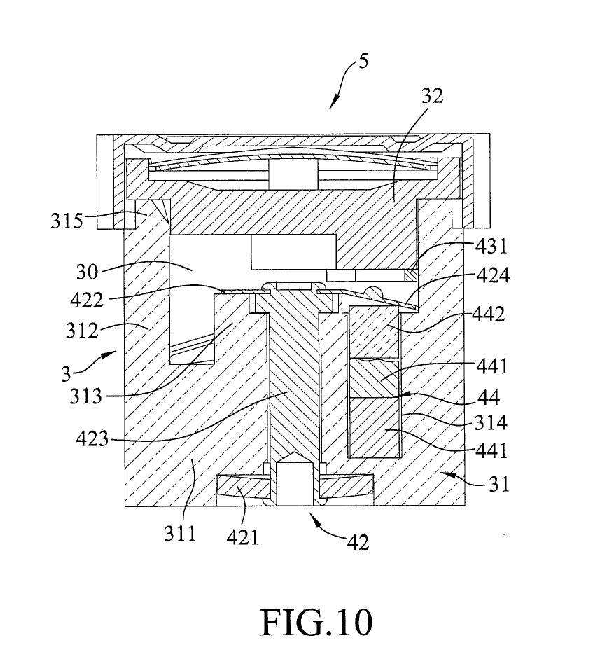

Referring to FIGS. 3 to 10, a temperature switch 100 according to an embodiment of the disclosure is configured to electrically connect with two electrical wires 21, 22, and can detect a heating temperature of a heater 23. When the detected temperature exceeds a preset temperature value, the temperature switch 100 will cut off power. The temperature switch 100 includes a base 3, a conducting mechanism 4 and a temperature control mechanism 5.

The base 3 includes a base body 31 and a cover body 32. The base body 31 is made of a ceramic material, and includes a base wall 311 having opposite top and bottom surfaces, a surrounding wall 312 extending upwardly from an outer periphery of and cooperating with the top surface of the base wall 311 to define a receiving chamber 30, a stepped platform portion 313 protruding from the top surface of the base wall 311 into the receiving chamber 30, a receiving hole 314 extending from the top of a lower step part of the stepped platform portion 313 toward the bottom surface of the base wall 311 and opening toward the receiving chamber 30, a first through hole 316 extending from the top of an upper step part of the stepped platform portion 313 through the bottom surface of the base wall 311 and spaced apart from the receiving hole 314, and a second through hole 317 extending through the top and bottom surfaces of the base wall 311 and spaced apart from the receiving hole 314 and the first through hole 316. An annular flange portion 315 is connected to a top end of the surrounding wall 312.

With reference to FIGS. 3, 6 and 7, the cover body 32 covers the receiving chamber 30, and has an annular mounting portion 321 abutting against a top end of the annular flange 315, an annular positioning portion 322 extending downward from the mounting portion 321 toward the receiving chamber 30, a protrusion portion 323 extending downward from a bottom surface of the positioning portion 322 into the receiving chamber 30, and an insert groove 324 extending through the positioning portion 322 and the protrusion portion 323. The positioning portion 322 has a limiting through hole 325 formed in the center thereof. The protrusion portion 323 is proximate to the limiting through hole 325 and has a positioning groove 326 indented inward from a bottom end thereof.

With reference to FIGS. 3 and 6 to 10, the conducting mechanism 4 includes a first conductive module 41, a second conductive module 42, a connection module 43 and a safety unit 44.

The first conductive module 41 includes a first terminal plate 411 located below the base wall 311 and electrically connected to the electrical wire 21, a first conductive plate 412 located in the receiving chamber 30, and a first connecting rod 413 inserted into the second through hole 317. The first conductive plate 412 has a resilient contact portion 414 extending obliquely toward the bottom of the protrusion portion 323. The resilient contact portion 414 has a push point 415 located below and corresponding to the limiting through hole 325, and a contact point 416 spaced apart from the push point 415 and located below the positioning groove 326. The first connecting rod 413 is positioned between and electrically connected to the first terminal plate 411 and the first conductive plate 412, and connects the first terminal plate 411 and the first conductive plate 412 to the base wall 311.

The second conductive module 42 includes a second terminal plate 421 located below the base wall 311 and electrically connected to the other electrical wire 22 and spaced apart from the first terminal plate 411, a second conductive plate 422 located in the receiving chamber 30, and a second connecting rod 423 extending into the first through hole 316. The second conductive plate 422 has a resilient contact portion 424 located above the receiving hole 314. The second connecting rod 423 is positioned between and electrically connected to the second terminal plate 421 and the second conductive plate 422, and connects the second terminal plate 421 and the second conductive plate 422 to the base wall 311.

The connection module 43 is disposed in the receiving chamber 30, and includes a conductive plate 431, and a conductive rod 432 that is inserted fittingly into the positioning groove 326 and that connects the conductive plate 431 to the protrusion portion 323 of the cover body 32. The conductive plate 431 has a contact portion 433 located above and corresponding to the resilient contact portion 424 of the second conductive plate 422, and an insert portion 434 adjacent to the contact portion 433 and inserted fittingly into the insert groove 324 to further position the conductive plate 431 to the protrusion portion 323. The contact point 416 of the resilient contact portion 414 releasably abuts against the conductive rod 432.

The safety unit 44 includes two deformable rods 441 and an isolator member 442 that are disposed in the receiving hole 314, that abut against each other and that are aligned along a longitudinal axis of the receiving hole 314. Specifically, the isolator member 442 is disposed between an upper one of the deformable rods 441 and the resilient contact portion 424 of the second conductive plate 422, and, together with deformable rods 441, pushes the resilient contact portion 424 to abut against the contact portion 433 of the conductive plate 431 prior to deformation of one of the deformable rods 441. Each deformable rod 441 melts when heated. Further, the isolator member 442 is made of a thermally non-conductive material to prevent the electrical current passing through the second conductive plate 422 and the temperature thereof from being conducted to the deformable rods 441.

The temperature control mechanism 5 includes a temperature-sensitive cover 51, a control rod 52 and a temperature-sensitive plate 53. The temperature-sensitive cover 51 is made of a thermally conductive material, is disposed above and covers the cover body 32, and is configured to contact the heater 23. The control rod 52 is inserted movably through the limiting through hole 325 in the cover body 32, and is made of a thermally non-conductive material. The temperature-sensitive plate 53 is thermally deformable and is located between the temperature-sensitive cover 51 and the cover body 32.

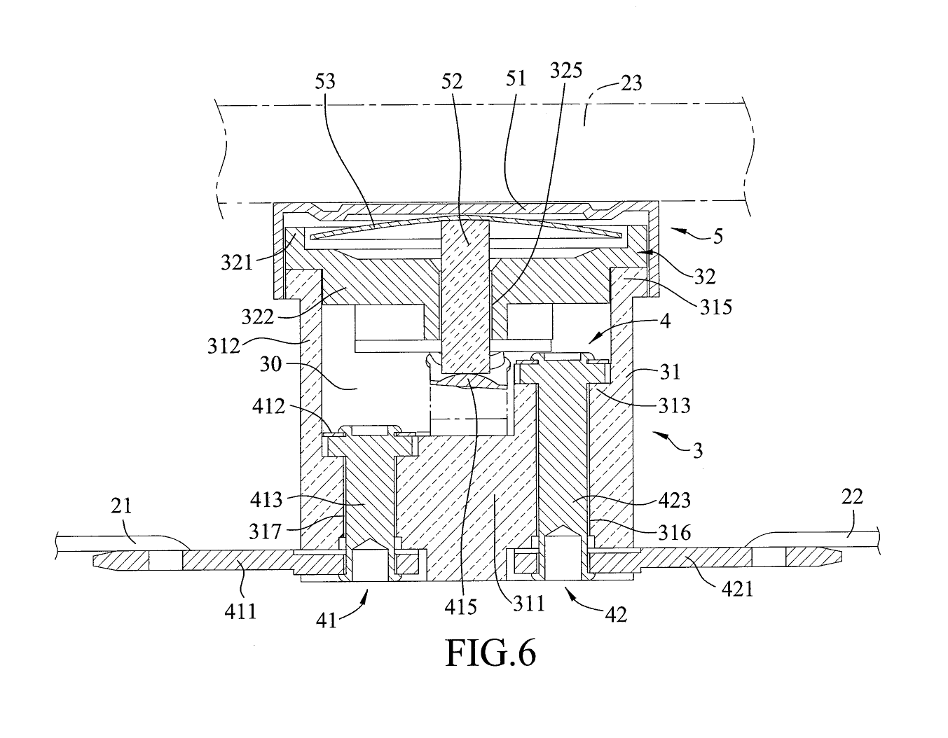

Referring back to FIGS. 6 to 9, when the temperature switch 100 of this disclosure is at an energized position, the temperature-sensitive plate 53 curves upwardly toward the temperature-sensitive cover 51, and the control rod 52 has a top end pushing a central portion of the temperature-sensitive plate 53 against the temperature-sensitive cover 51, and a bottom end abutting against the push point 415 of the resilient contact portion 414 of the first conductive plate 412. At this time, the contact point 416 of the first conductive plate 412 abuts against the conductive rod 432 of the connection module 43, and the safety unit 44 pushes the resilient contact portion 424 of the second conductive plate 422 to abut against the contact portion 433 of the conductive plate 431 of the connection module 43. As such, the electrical current entering the electrical wire 21 can flow through the first conductive module 41, the connection module 43, the second conductive module 42 and out of the electrical wire 22, or vice versa.

When the temperature of the heater 23 is transmitted to the temperature-sensitive plate 53 through the temperature-sensitive cover 51, and the temperature-sensitive plate 53 detects a temperature reaching a preset temperature value, the temperature-sensitive plate 53 deforms and curves downward to push the control rod 52 to move downward. The downward movement of the control rod 52 drives the resilient contact portion 414 to also move downward, thereby separating the first conductive module 41 from the connection module 43. At this time, the electrical current cannot flow between the first conductive plate 412 and the connection module 43, and the temperature switch 100 is switched from the energized position to a normal power off position.

Referring back to FIGS. 6, 9 and 10, during operation of the temperature switch 100, when the temperature of the heater 23 is higher than the preset temperature value, but because the temperature-sensitive plate 53 fails to function and cannot deform, or the contact point 416 of the first conductive plate 412 is abnormally stuck to the conductive rod 432 of the connection module 43, the electrical current will flow continuously through the conducting mechanism 4, thereby causing the temperature inside the receiving chamber 30 to increase. When the temperature in the receiving chamber 30 increases which causes one of the deformable rods 441 to melt or deform, the height of the entire safety unit 44 is reduced. Because the height of the entire safety unit 44 is reduced, and without the safety unit 44 pushing the resilient contact portion 424 of the second conductive plate 422 against the conductive plate 431 of the connection module 43, the resilient contact portion 424 resiliently moves away from the conductive plate 431, so that the electrical current cannot flow between the connection module 43 and the second conductive module 42. At this time, the temperature switch 100 is switched from the energized position to a safety cut-off position.

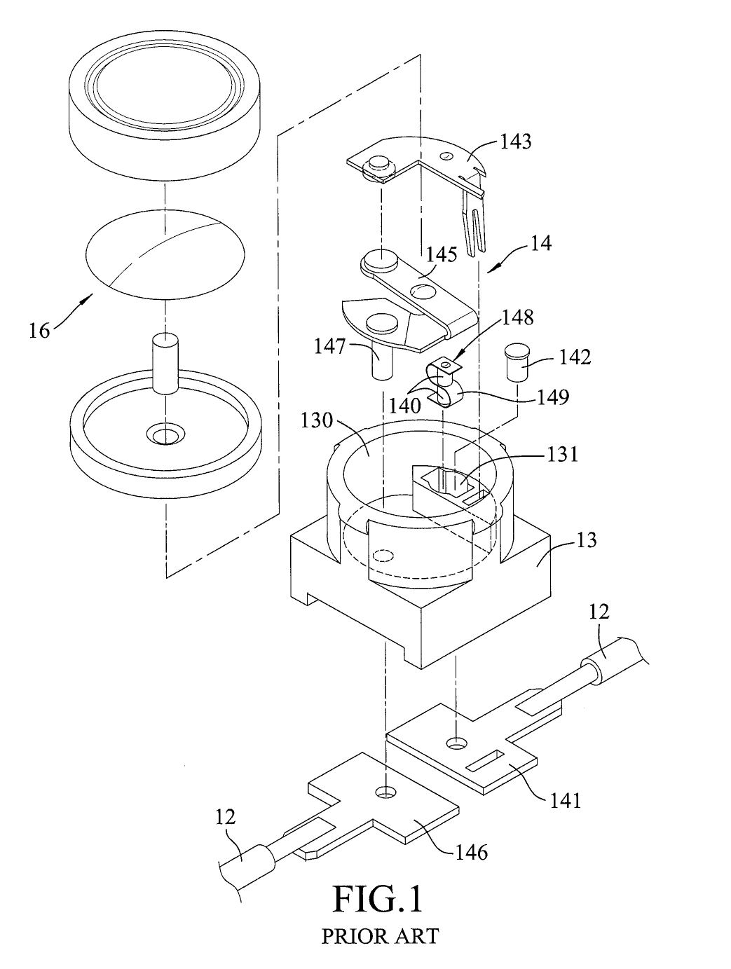

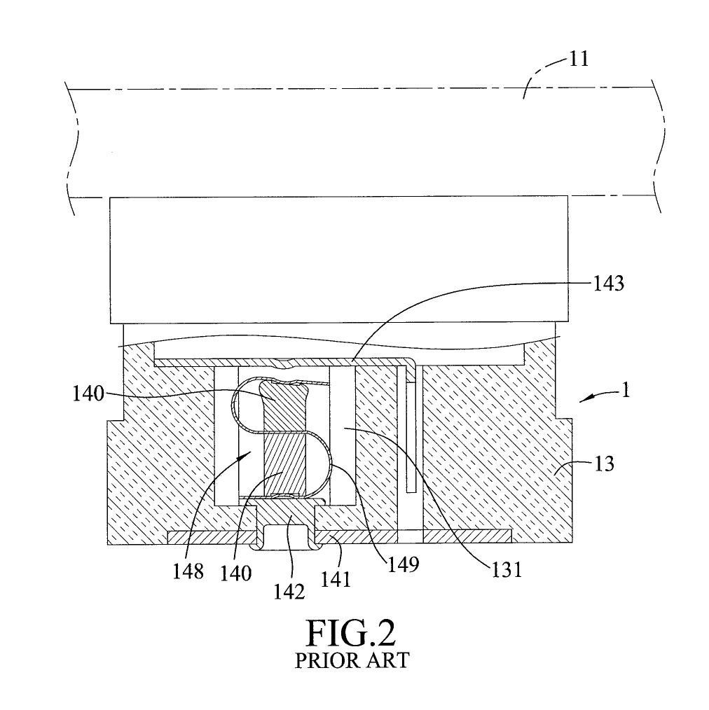

From the foregoing description, when compared with the conventional temperature switch shown in FIGS. 1 and 2, apart from using the deformable structure of the deformable rods 441 to place the temperature switch 100 at the safety cut-off position when the temperature exceeds the preset temperature value, and further through the disposition of the components of the temperature switch 100, the electrical current can be prevented from directly flowing through the deformable rods 441 to ensure the safety function of the safety unit 44. Moreover, the first and second conductive plates 412, 422 can be riveted to the base body 31 through the first and second connecting rods 413, 423, respectively. With the conductive rod 432 inserted fittingly into the positioning groove 326, and with the insert portion 434 of the conductive plate 431 inserted fittingly into the insert groove 324, the conductive plate 431 can be fixedly positioned to the cover body 32. Therefore, the components of the temperature switch 100 can be conveniently and stably assembled.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A temperature switch for electrical connection with two electrical wires, comprising:
a base having a receiving hole;
a conducting mechanism mounted on said base and including a first conductive module for electrically connecting one of the electrical wires, a second conductive module for electrically connecting the other one of the electrical wires, a connection module connected electrically and releasably to said first and second conductive modules, and a safety unit including two deformable rods that are disposed in said receiving hole, that abut against each other, that are aligned along a longitudinal axis of said receiving hole, and that push said second conductive module to abut against said connection module; and
a temperature control mechanism mounted on said base and controlling said first conductive module to move away from said connection module so as to switch said temperature switch from an energized position to a normal power off position;
wherein said second conductive module is moved away from said connection module when one of said deformable rods is deformed by temperature to switch said temperature switch from the energized position to a safety cut-off position.

2. temperature switch as claimed in claim 1, wherein said safety unit further includes an isolator member disposed between one of said deformable rods and said second conductive module, said isolator member being made of a thermally non-conductive material.

3. temperature switch as claimed in claim 1, wherein said base includes a base body defining a receiving chamber, and a cover body covering said receiving chamber, said connection module being disposed in said receiving chamber, and including a conductive plate and a conductive rod connecting said conductive plate to said cover body, said first conductive module releasably abutting against said conductive rod, and wherein said second conductive module abuts against said conductive plate prior to deformation of said one of said deformable rods, and moves away from said first conductive plate when said one of said deformable rods is deformed.

4. The temperature switch as claimed in claim 3, wherein said cover body has an insert groove, and said conductive plate has an insert portion inserted into said insert groove.

5. The temperature switch as claimed in claim 3, wherein:
said first conductive module includes a first terminal plate configured to electrically connect with the one of the electrical wires, a first conductive plate located in said receiving chamber, and a first connecting rod positioned between said first terminal plate and said first conductive plate and connecting said first terminal plate and said first conductive plate to said base body, said first conductive plate having a resilient contact portion releasably abutting against said conductive rod; and
said second conductive module includes a second terminal plate configured to electrically connect with the other one of the electrical wires and spaced apart from said first terminal plate, a second conductive plate located in said receiving chamber and releasably abutting against said conductive plate of said connection module, and a second connecting rod positioned between said second terminal plate and said second conductive plate and connecting said second terminal plate and said second conductive plate to said base body.

6. The temperature switch as claimed in claim 5, wherein said temperature control mechanism includes a temperature-sensitive cover disposed above and covering said cover body, a temperature-sensitive plate located between said temperature-sensitive cover and said cover body, and a control rod inserted through said cover body and having one end pushing said temperature-sensitive plate against said temperature-sensitive cover, and the other end abutting against said resilient contact portion of said first conductive plate.
